(19) United States
(12) Patent Application Publication
(10) Pub. No.: US 2013/0273316 A1
(43) Pub. Date: Oct. 17, 2013

(54) Device and Method for Wave Detection, Electrical Conduction and Fracture Resistance by Elastic Stress Patterns Induced by the Rotation of Three Dimensional Microstructural Elements

(71) Applicant: Christine Marie Kennefick, Reston, VA (US)

(72) Inventor: Christine Marie Kennefick, Reston, VA (US)

(21) Appl. No.: 13/445,946

(22) Filed: Apr. 13, 2012

(51) Int. Cl. B32B 5/00

(52) U.S. Cl. 428/141

(57) ABSTRACT

The invention is a monolithic material texture of three dimensional microstructural elements that rotate within the texture or material matrix under an applied load to produce elastic stress patterns unique to the shape, orientation and size of the microstructural elements. The applied load can arise from a mechanical load, electromagnetic wave or charge carrier. The elastic stress patterns, by themselves or superimposed upon the incoming stress, can oscillate in time with the incoming force or with the wavelike properties of charge carriers. The elastic stress patterns are used to identify the frequency, phase, amplitude and direction of an incoming wave. The elastic stress patterns may also facilitate electrical conduction and power, prevent fracture or promote material separation by the redistribution, buildup and release of elastic strain or potential energy at the atomic scale, nanoscale, micron scale or higher.

### TECHNICAL FIELD

The field of the invention encompasses electrical power, electrical conduction, wave characterization and resistance to fracture without the use of batteries and fossil fuels.

### BACKGROUND ART

An example of a controlled microstructure to enhance electrical, magnetic and optical performance are ordered epitaxial layers of non-superconducting nanodots and nanorods (Goyal, Amit, U.S. Pat. No. 8,119,571). Arrays of nanodots have also been coupled with laser light and voltage pulses to produce a semiconducting memory device (Drndic, Marija and Fischbein, Michael D., U.S. Pat. No. 7,813,160). In the field of tissue engineering, another invention encompasses the arrangement and adhesion of cells on a substrate (Borenstein, Jeffrey P., Carter, David and Vacanti, Joseph P., U.S. Pat. No. 8,097,456).

In contrast to the inventions just described, the device and method presented here does not rely upon substrates, epitaxial layers and lithography. It has the advantage of simpler steps to material production and a form of electrical conduction that does not rely upon batteries or upon fabricated patterns for semiconduction. These distinct differences are more fully described in the next section.

The present invention relies upon an elastic rotation of three dimensional microstructural elements, which can be at the atomic, nanometer, micron, or even larger length scales. The rotation produce elastic stress patterns in the material. Furthermore, the electrical conduction will be either superconduction or the conduction of H+ ions which move as their own wavelike forces interact with the elastic stress patterns. This mechanism is therefore in contrast to a traditional piezoelectric effect in which a mechanical force produces a voltage to drive electrical conduction. Architectures of nanotubes and nanotrees in an electrically insulating material for piezoelectric conduction have been found (Shi, Yong and Xu, Shiyou, U.S. Pat. No. 8,093,786). Movement of charge carriers by the local redistribution of electronic potential energy and elastic strain energy is also in contrast with anisotropic semiconduction (Lazarov, Pavel I., U.S. Pat. No. 8,124,966).

### SUMMARY OF THE INVENTION

### Technical Problem

Power and signal collection currently relies upon fossil fuels, batteries and wave interference. To increase resolution and reliability of a signal, and at the same time have equipment and vehicles run for long lengths of time without fossil fuels and batteries, a new process should to be optimized and fabricated that takes place solely within a monolithic material microstructure.

### Solution to the Problem

The invention provides a collection of three dimensional microstructural elements that rotate elastically under the influence of an incoming force. The incoming force can be a wave signal or can arise from the wavelike nature of a charge carrier. Once the microstructural elements rotate, they provide an elastic stress pattern that is unique to the direction and frequency of the incoming force and to the shape, size, orientation and spacing of the microstructural elements themselves. This elastic stress pattern interacts with the wave modes of the incoming force to generate electrical power and unique electrical signals without the use of a battery, voltages, fossil fuels, or wave interference outside the monolithic material.

### Advantageous Effects of the Invention

One advantage of the invention is that it detects the angle of incidence and frequency of an incoming wave directly within a monolithic microstructure without any arrays of dots, lines or microdevices. The invention creates a unique and identifying elastic stress pattern within the monolithic material microstructure. Such an internal mechanism has potential for greater security and resolution of a wave signal than those methods currently on the market.

A second advantage of the invention is that it provides electrical conduction and energy directly through wave motion and strain energy and without the use of batteries and semiconducting device architectures. Once there is a mechanical impulse to start the electrical conduction, there are no batteries that need to be recharged. A device with this type of electrical conduction could run longer than those machines, devices and vehicles that are rely directly upon batteries and fossil fuels for power.

### BRIEF DESCRIPTION OF THE DRAWINGS

Reference will be made to the accompanying drawings, which can represent any length scale from the atomic to continuum levels. The size, shape, orientation and spacing of the elements shown are not exact but are representative of any texture that produces the elastic stress patterns and electrical conduction covered in the Claims and Detailed Description.

FIG. 1 shows a sample material texture whose elements can rotate under the applied force from an incoming wave or from the wavelike properties of a charge carrier.

FIG. 2 shows the formation of an elastic stress pattern unique to the frequency and angle of the incoming wave and unique to the size, shape and orientation of the microstructural element.

FIG. 3 shows the production and release of elastic strain energy as the forces from the wavelike nature of a charge carrier superimpose upon an elastic stress pattern.

### DETAILED DESCRIPTION OF THE INVENTION

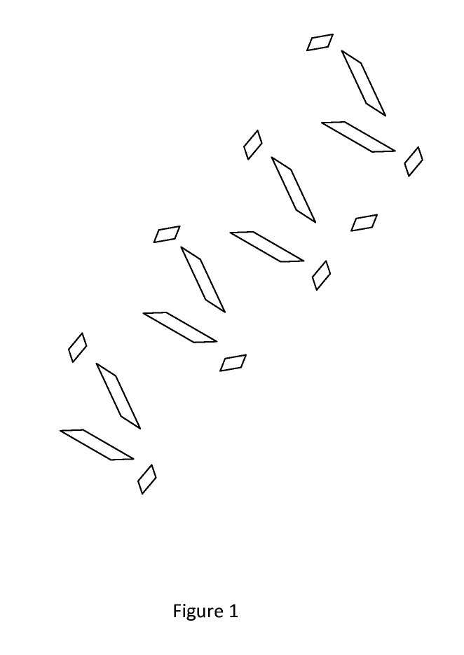

The invention is a monolithic texture of microstructural entities, as shown schematically in FIG. 1. It is a monolithic material texture in the sense that to fabricate the texture, one does not need to deposit layers, dots, lines or devices onto a substrate material. The atomic clusters, grains, particles or phases comprising the texture can be contiguous to one another and as a whole comprise the material texture. The atomic clusters, grains, particles or phases can also be linked to one another within a matrix material. The atomic clusters, grains, particles or phases can also be separate from one another and comprise a pattern embedded in a matrix material. The fabrication of the invention, however, will involve mixing and heating together crystallites of material without deposition of layers or lithography techniques.

For simplicity of words in this application, the atomic clusters, grains, particles or phases that comprise the material texture as a whole or are embedded in another material matrix, will be referred to as microstructural elements.

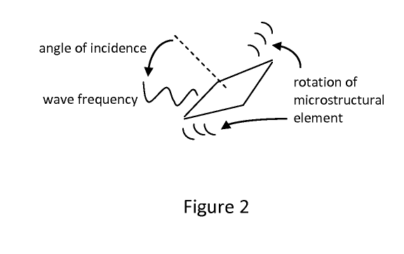

An incoming force provides a torque that elastically rotates one or more of the microstructural elements a fraction of a radian within the material texture or within the material matrix. As shown in FIG. 2, the incoming force can arise from a wave with distinct frequency, angle of incidence and amplitude. The force could also be a static force provided by a mechanical clamp onto the piece of material.

Elastic rotation of each three dimensional microstructural element will produce its own elastic stress pattern within the material, as shown schematically in FIG. 2. In this invention, the full amount of rotation for any particular microstructural element can be correlated to angle of incidence and amplitude of incoming force. When a collection of microstructural elements, whether bundled or not, each produces its own elastic stress pattern dependent upon the amount of rotation each element undergoes, the invention can be used to identify the amplitude and angle of incidence of the incoming force.

Rotation of an atomic cluster is defined to be a rotation accommodated by a redistribution of atomic and electronic potential energy around the atoms in the cluster. The rotation can be a fraction of a radian or more than a radian. Rotation of a grain or composite particle is envisioned to be that of an elongated grain or particle that rotates within the material when the incoming force is applied to one or both ends. Rotation of a material phase, under the influence of a torque from an incoming force, may include all of the material phase or part of the material phase as an elongated portion. In all the cases of rotation of atomic clusters, grains, particles and phases, the pivot point of the rotation can be at the center, off center, or at any edge or corner of the microstructural element.

The elastic stress pattern around each microstructural element will be unique to its symmetry, size and pivot point of rotation. The incoming stress is superimposed upon the elastic stress pattern of the microstructural elements to create yet another distinctive stress pattern. This second stress may appear and disappear in an oscillatory fashion as both the incoming force and the elastic stress pattern oscillate from an incoming wave. In this invention, either the stress pattern from the microstructural elements or a second pattern that includes the superposition an incoming force can be used to identify the nature of the incoming wave, active electrical conduction or suppress fracture.

In particular, an incoming wave can be identified by both the stress pattern from the microstructural elements and any superimposed stress that may arise from the incoming wave itself. The rotation of the microstructural elements will oscillate with the frequency of the incoming wave. Hence the stress pattern and the electrical signal activated by the stress pattern will have a frequency related to that of the incoming wave. Both the pivot point of rotation of each microstructural element and any superposition of the incoming wave with the elastic stress from the rotation will give an indication of the angle of incidence of the incoming wave. The magnitude of the rotation angle of the microstructural elements and the final stress pattern will give an indication of the amplitude of the incoming wave.

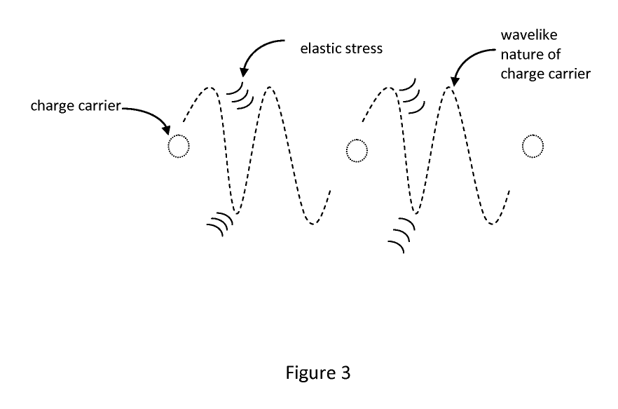

The stress pattern set up by the rotation of the microstructural elements and the incoming force can be used to activate the motion of charge carriers for a distinct electrical signal. FIG. 3 shows the motion of a charge carrier from the redistribution, buildup and release of elastic strain energy around it at an atomic, nanoscale or microscale level. In this invention, the charge carrier could be an electron in normal conduction or superconduction. The charge carrier could also be a H+ ion for protonic conduction at room and elevated temperatures. For all the types of conduction, the elastic stress pattern from rotation of microstructural elements facilitates electrical conduction past thermal vibrations, grain boundaries, particle-matrix boundaries, or interphase boundaries.

Uses of the activation of electrical conduction are threefold. Electrical power from the redistribution, buildup and release of strain energy around the charge carrier can be used to supplement or replace power from fossil fuels and batteries. Secondly, electrical conduction from the redistribution of potential energy would in this invention be much more powerful than energy arising from thermal vibrations. Hence the conduction could be used at elevated temperatures in ceramics through protonic conduction. Or it may be used in normal conduction or superconduction at temperatures higher than those in present applications. Finally, the unique electrical signals activated by distinct elastic stress patterns could provide information on and an image of a wave signal. Since the elastic stress pattern can be anywhere at the atomic to continuum levels, the wave detected can be mechanical or electrical at a wide range of wavelengths.

The stress pattern from the rotation of the microstructural elements may also be designed in this invention to arrest or even prevent crack propagation. The stress pattern might block or nullify an incoming stress, promote strain that might otherwise not be accommodated in the material, or facilitate the dissipation of elastic strain energy before any crack propagation or fracture occurs.

### INDUSTRIAL APPLICABILITY

The invention has important industrial applicability in electrical conduction, signal collection, signal processing and structural integrity.

For all modes of transportation, machinery for the manufacture of goods, and both consumer and industrial electronics and computers, it is vital that reliance on fossil fuels and batteries be reduced, or even eliminated. Successful prototyping, implementation and widespread fabrication of the present invention would provide electrical power by means of a mechanically induced strain energy release rather than by batteries that would need periodic recharging. The mechanical input, if provided within a closed loop within this invention, would eliminate the need for power from fossil fuel sources as input.

With this invention, signal collection and signal processing have the potential to be of higher resolution and to provide excellent integrity in a small space. The invention does not rely upon wave interference outside the material. Instead, it provides, as a signal, a unique elastic strain pattern directly induced by the incoming wave itself. The unique elastic strain energy pattern then mechanically activates a distinctive electrical signal within a monolithic volume of material. The invention can function as a sensor or actuator that is smaller, lighter in weight and within a monolithic volume of material, which could be more secure than what is available with current electronics.

Finally, the invention can provide enhanced structural stability to machinery and buildings. The incoming wave can be a from wind, sound or an impact from another object. With this invention, the material can respond with an elastic stress pattern that can both detect the nature of the incoming disturbance and set up elastic stresses to block any undesired buildup of strain energy.

### CITATIONS

| Patent Number | Inventor(s) |
|---|---|
| 8,124,966 | Lazarov, Pavel I. |
| 8,119,571 | Goyal, Amit |
| 8,097,456 | Borenstein, Jeffrey P., Carter, |
| | David and Vacanti, Joseph P. |
| 8,093,786 | Shi, Yong and Xu, Shiyou |
| 7,813,160 | Drndic, Marija and Fischbein, Michael D. |

What is claimed:

1. A microstructural material texture that, upon elastic rotation of three dimensional structural elements under an incoming wave, produces an elastic stress or potential energy pattern that in turn produces a distinct electrical signal pattern that arises from a reshaping of the wavelike characteristics of charge carriers rather than from a voltage, and that facilitates within a monolithic material texture the identification of the frequency, incoming angle, type and amplitude of the incoming wave.

2. A microstructural material texture that, upon elastic rotation of three dimensional monolithic structural elements under an incoming wave, mechanical load or elastic stress pattern in the material, facilitates charge carrier conduction and the production of electrical energy not by forming a voltage, but by reshaping the wavelike characteristics of charge carriers and by the release, buildup and redistribution of elastic strain energy or potential energy of any or all monolithic structural elements.

3. A microstructural material texture that, upon elastic rotation of three dimensional monolithic structural elements under an incoming wave, static mechanical load or time dependent mechanical load, not only prevents fracture and enhances structural integrity, but also can promote the selective separation of material by reshaping the wavelike characteristics of charge carriers and by redistributing the buildup and release of elastic strain energy.
